(19) United States
(12) Patent Application Publication
(10) Pub. No.: US 2022/0080669 A1
(43) Pub. Date: Mar. 17, 2022

(54) POWDER-FUSING ENERGY SOURCE CONTROL

(71) Applicant: Hewlett-Packard Development Company, L.P., Spring, TX (US)

(72) Inventors: Adrien Chiron, Sant Cugat del Valles (ES); Daniel Pablo Rosenblatt, Sant Cugat del Valles (ES); Macrc Borras Camarasa, Sant Cugat del Valles (ES)

(73) Assignee: Hewlett-Packard Development Company, L.P., Spring, TX (US)

(21) Appl. No.: 17/418,178

(22) PCT Filed: May 31, 2019
(86) PCT No.: PCT/US2019/034818

§ 371 Date: Jun. 24, 2021

(51) Int. Cl. B29C 64/393; B29C 64/153; B33Y 10/00; B33Y 30/00; B33Y 50/02

(52) U.S. Cl. CPC B29C 64/393; B29C 64/153; B33Y 50/02; B33Y 30/00; B33Y 10/00

(57) ABSTRACT

Powder-fusing energy source control comprising the generating of printer control instructions to control a powder-fusing energy source based on a spectrophotometry measurement of build powder in a three-dimensional printing system.

### BACKGROUND

A three-dimensional printer may generate a three-dimensional object by printing a series of two-dimensional layers on top of one another. In some three-dimensional printing systems, each layer of an object may be formed by placing a uniform layer of powder on a build bed of a printer, and placing liquid printing agents at the specific points at which it is desired to solidify the powder to form the layer of the object. A fusing lamp may then apply energy to the layer of powder, to cause the powder to solidify in accordance with where printing agents were applied.

### BRIEF DESCRIPTION OF THE DRAWINGS

FIG. 1 is a schematic diagram showing components of an additive manufacturing system according to an example;

FIG. 2 is a schematic diagram showing components of an additive manufacturing system according to another example;

FIG. 3 is a schematic diagram showing components of part of an additive manufacturing system according to an example;

FIG. 4 is a schematic diagram showing components of part of an additive manufacturing system according to another example;

FIG. 5 is a schematic diagram showing the absorption/reflection of radiation from a heat source on a printer carriage passing over a powder bed according to an example;

FIG. 6 is a flowchart showing a method for controlling an output power of a powder-fusing energy source according to an example;

FIG. 7a is a table showing how the colourization of build powder affects build part temperature in an additive manufacturing system according to an example;

FIG. 7b is a table showing how the output power of a powder-fusing energy source can be scaled to compensate for a colourization of build powder according to an example;

FIG. 8 is an example of a controller configured to generate printer instructions according to an example; and

FIG. 9 is an example of a computer readable medium comprising instructions to control an output power of a powder-fusing energy source in a three-dimensional printer according to an example.

### DETAILED DESCRIPTION

In three-dimensional printing, also referred to as additive manufacturing, a layer of a three-dimensional object may be generated by solidifying a build material, which may be a powder. The process of generating a layer may be referred to as a fusing cycle, and the fusing cycle may be repeated several times to form a plurality of successive layers, thereby generating the three-dimensional object. A first stage of the fusing cycle may comprise providing a layer of powdered build material; a subsequent stage of the fusing cycle may comprise distributing a fusing agent over the layer of powdered build material in a predetermined pattern; a subsequent stage of the fusing cycle may comprise applying energy over the print bed so that portions of the powder on which fusing agent is applied heat up and coalesce. In a final stage of the fusing cycle, the print bed cools and the portions of the powder to which the fusing agent has been applied solidify, thereby forming a layer of the object.

Examples described herein allow the powder-fusing energy source to be controlled in a consistent manner, such that the temperature of printed parts is independent of the spectrophotometric traits of the build powder in use. This may be achieved by controlling an output power of the heat source based on an obtained spectrophotometry measurement of the build powder. Controlling the temperature of the printed parts may prevent cosmetic defects (for example thermal bleeding) and may improve dimensional uniformity and mechanical properties uniformity in parts printed from different three-dimensional printers.

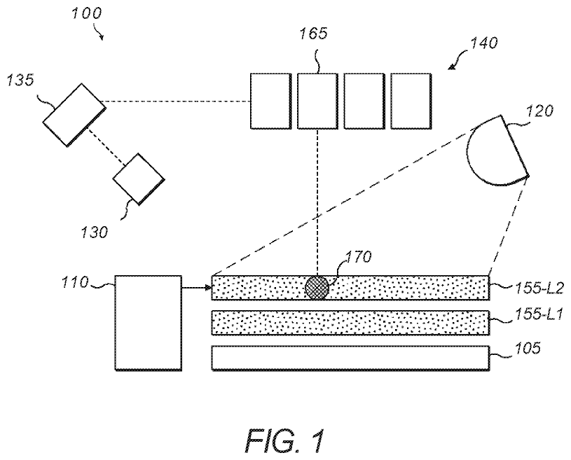

Referring to FIG. 1, there is shown an example of an additive manufacturing system 100. Although the example additive manufacturing system 100 is provided to better understand the context of the examples described herein, those examples may be applied to a variety of additive manufacturing systems including, amongst others, other agent printing-based systems.

In this example, the additive manufacturing system 100 comprises a build platform 105. In this example, the additive manufacturing system 100 comprises a supply mechanism 110 to form a base of build material upon the build platform 105. In this example, the additive manufacturing system 100 comprises one or more radiation sources 120 (or powder-fusing energy source) to heat a layer of build material. In this example, the additive manufacturing system 100 comprises a thermal sensor 130 to measure a thermal profile of the base. In this example, the additive manufacturing system 100 comprises a controller 135. In this example, the additive manufacturing system 100 comprises a printing agent deposit mechanism 140. The printing agent deposit mechanism 140 applies at least one printing agent. Examples of printing agent include, but are not limited to, fusing agents and binding agents.

The features shown in FIG. 1 may be used to produce both a base for additive manufacturing and one or multiple three-dimensional objects upon the base. For example, the supply mechanism 110 may be configured to supply at least one build material layer. This may form a layer of the base or an object to be produced. At least one printing agent may be deposited on one or more of the layers by the printing agent deposit mechanism 140. In this example, the supply mechanism 110 supplies a powdered build material in successive layers. Two layers are shown in FIG. 1: a first layer 155-L1 upon which a second layer 155-L2 has been formed by the supply mechanism 110. The supply mechanism 110 may be arranged to move relative to the build platform 105 such that successive layers are formed on top of each other.

The one or more radiation (or powder-fusing energy) sources 120 may comprise a lamp, for example a short-wave incandescent or infrared lamp. The one or more radiation sources 120 may be another light source constructed to emit electromagnetic radiation across a range of wavelengths to heat the base. For example, the radiation source 120 may be a halogen lamp. The additive manufacturing system 100 may comprise one radiation source to heat the base or may comprise a plurality of radiation sources to heat the base. Radiation sources may have other uses. For example, radiation sources may comprise lighting systems to illuminate the working area or to fuse a build material.

An infrared “pre-heat” lamp may be used to heat the base. The pre-heat lamp may be located above the build platform 105, for example such that it heats at least an upper surface of the base. The pre-heat lamp may be controlled to heat the base to a temperature just below a melting point of the build material. Another radiation source may then be used during construction of a 3D object. For example, in one implementation, a separate fusing lamp may be used. The fusing lamp may apply energy to cause fusing of build material on which a fusing agent has been applied. In some additive manufacturing systems such as selective laser sintering (SLS) systems, the radiation source may be a powder-fusing laser or an array of powder-fusing lasers.

The thermal sensor 130 may be configured to measure a thermal profile of the base. The thermal profile may comprise a two-dimensional representation of the temperature of an upper surface of the base. The thermal sensor 130 may comprise a thermal imaging camera. The thermal imaging camera may comprise one or more infrared sensors. The thermal sensor 130 may comprise an array of thermopiles and an optical system such that the infrared sensor is an infrared camera. The optical system may comprise a system of lenses such that an infrared image is formed by the infrared camera. In such an example, each thermopile may return a value representative of radiation integrated within its spectral window.

The printing agent deposit mechanism 140 may comprise at least one print head 165 to deposit a printing agent. The printing agent deposit mechanism 140 may deposit different types of fluid printing agent, for example a fusing agent and a detailing agent. The fusing agent may be used to increase heating of the base. The detailing agent may be used to decrease heating of the base. For example, the printing agent deposit mechanism 140 may comprise an Inkjet′ deposit mechanism for printing a plurality of printing agents onto layers of powdered build material 155. A print head may be adapted to deposit one or multiple printing agents onto layers of powdered polymer build material that form the base. Print heads within the deposit mechanism may be arranged to deposit a particular printing agent upon defined areas within a plurality of successive build material layers.

A fusing agent (sometimes also referred to as a “coalescing agent”) may increase heating of portions of the layer on which it has been printed by acting as an energy absorbing agent that causes build material on which it has been deposited to absorb more energy, for example from the radiation source 120, than build material on which no fusing agent has been deposited. This may cause build material to heat up. When heating the layer, a desired temperature for the layer may be below a fusing temperature of the build material. Hence, application of fusing agent causes heating of the layer but does not cause melting and fusing of the build material. However, when constructing a 3D object, build material may be heated above the fusing temperature, and the fusing agent may act to cause the build material to melt, coalesce or fuse, and then solidify after cooling. In this manner, solid parts of the 3D object may be constructed. A fusing agent is different from a binding material (or “binder”) in that a fusing agent acts as an energy absorbing agent that causes build material on which it has been deposited to absorb more energy, whereas a binding material or binder chemically acts to draw build material together to form a cohesive whole.

A detailing agent (sometimes also referred to as a “modifying agent” or “modifier”) may act to modify the effect of a fusing agent and/or act directly to cool build material. When heating a layer, a detailing agent may thus be applied to reduce a heating effect of previously applied fusing agent and/or to directly reduce the temperature of the build material. When constructing a 3D object, a detailing agent may be used to form sharp object edges by inhibiting a fusing agent outside of an object boundary and thus preventing solidification in exterior areas of a cross-section. During construction of an object, a detailing agent may also be used to prevent thermal bleed from a fused area to a non-fused area and to prevent fusing in “blank” or “empty” portions of an object, for example in internal cavities. At the end of production of an object, unfused build material may be removed to reveal the completed object.

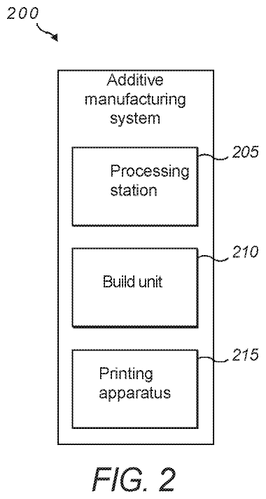

Referring to FIG. 2, there is shown example of an additive manufacturing system 200.

In this example, the additive manufacturing system 200 comprises a processing station 205, a build unit 210 and a printing apparatus 215. The processing station 205 may be used to load build material into the build unit 210. For example, one or more cartridges comprising build material may be inserted into the processing station 205 and the processing station 205 may load build material, for example from the one or more cartridges, into the build unit 210. The build unit 210 may be removed from the processing station 205 and slotted or otherwise inserted into the printing apparatus 215, thereby moving the build material loaded into the build unit 210 by the processing station 205 into the printing apparatus 215. The printing apparatus 215 may use printing agents that have been loaded into the printing apparatus 215, along with the build material in the build unit 210, to produce a three-dimensional object on the build unit 210. The build unit 210 may be removed from the printing apparatus 215 and slotted back into the processing station 205. The processing station 205 may for example aid cooling of the three-dimensional object produced in the printing apparatus 215.

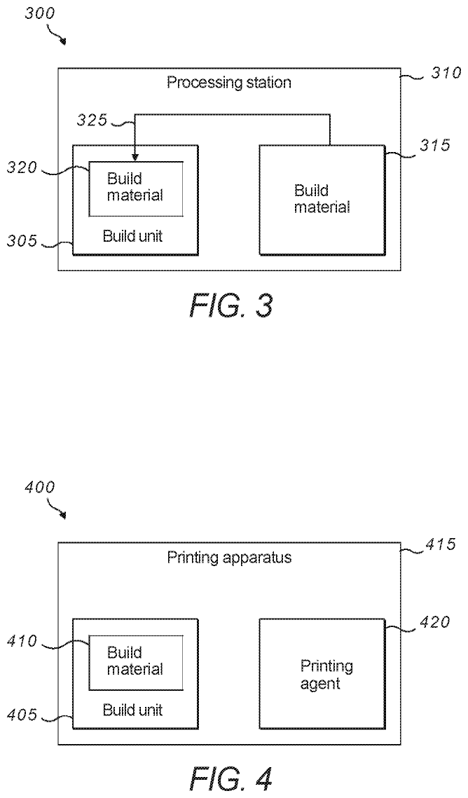

Referring to FIG. 3, there is shown example of part of an additive manufacturing system 300.

In this example, a build unit 305 is located inside a processing station 310. In this example, the processing station 310 includes one or more consumable units 315, for example cartridges, comprising build material. Build material is loaded from the one or more consumable units 315 into one or more building material stores 320 in the build unit 305 as indicated by arrow 325. Following printing operations, build material is depleted to produce printed parts. Some of the build material remains in the building material store 320 may be re-used in further printing operations. The building material stores 320 may be refilled with build material from the one or more consumable units 315 between printing operations. The build material from the one or more consumable units 315 may have differing spectrophotometric traits to the re-used build material in the building material stores 320. For instance, in some cases, re-used build material may become oxidized, causing it to exhibit changes in spectrophotometric properties, affecting the amount of energy absorbed by printed parts during printing operations. In one example, white build powder may begin to turn yellow, or even brown in extreme cases as a result of oxidation (or other chemical reactions).

Referring to FIG. 4, there is shown example of part of an additive manufacturing system 400.

In this example, a build unit 405 comprising build material 410 has been moved from a processing station into a printing apparatus 415. The printing apparatus 415 also includes printing agent 420. The printing agent 420 may for example be stored in one or more consumable units, for example cartridges, in the printing apparatus 415.

A plurality of factors can affect the temperature of the printed part after the heat source has applied energy to the print bed. These factors may include the power of the heat source, the transparency of protective glass provided between the heat source and the print bed, the amount of fusing agent used (if used at all) and the cooling process within the build unit.

The temperature of the printed part after the heat source has applied energy to the print bed is also significantly affected by the spectrophotometric traits of the build powder. Spectrophotometry is the quantitative measurement of the reflection or transmission properties of a material as a function of wavelength. It is more specific than the general term electromagnetic spectroscopy in that spectrophotometry deals with visible light, near-ultraviolet, and near-infrared. In three-dimensional printing operations, such as binder-jet systems, white build powder such as fresh nylon 12 (PA12) absorbs as little as 22% of incident radiation from a typical fusing lamp (blackbody emitter) operating at 3000 degrees Kelvin. It was established using spectroscopic analysis of light reflected from the powder that this low absorption corresponds to full or nearly full absorption of deep infrared wavelengths, and nearly full reflection of visible and near-IR wavelengths, and partial reflection at wavelengths between deep-IR and near-IR. This amount of absorbed energy is insufficient to bring the build powder near its melting temperature and so some of the build powder remains unfused, which could compromise the quality of the printed objects. The remaining 78% of the radiation is reflected back towards the powder-fusing energy source or other areas of the powder bed. Some three-dimensional printing systems will include one or more reflectors positioned near to or behind the powder-fusing energy source, causing the reflected energy to be reflected back and forth between the powder bed and the reflector until either it is absorbed by build powder or it attenuates over multiple reflections.

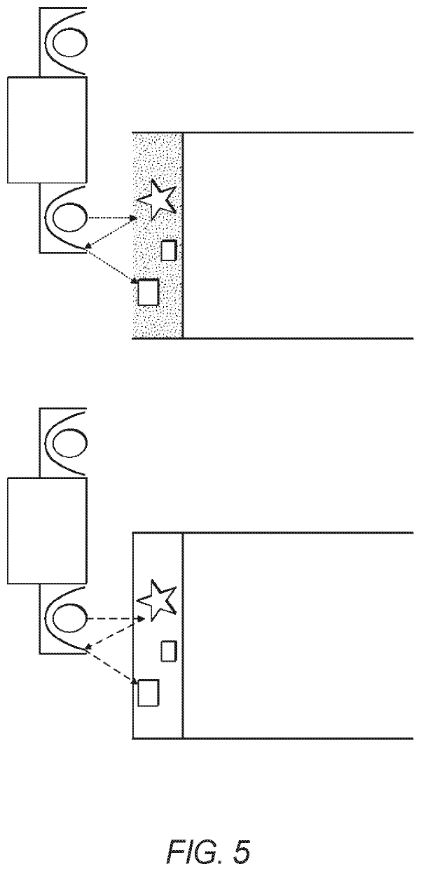

The amount of energy absorbed by a printed part therefore depends on the spectrophotometry of the surrounding build powder. In some cases, the reflected energy absorbed by a printed part can account for up to 40% of the energy it absorbs, therefore the spectrophotometry of the surrounding build powder can have a significant effect on the temperature of the printed part after the heat source has applied energy to the print bed. Where build powder becomes discolored as a result of oxidization or otherwise, it absorbs more energy and reflects less, which can mean that surrounding powder absorbs energy that could have been reflected and then absorbed at the focus point to form a printed part. Variations in reflection and absorption can lead to some powder absorbing more or less energy than the build powder that is used to tune the re-radiation correction. Therefore, yellowing build powder can cause a printed part to remain at an energetic deficit, reaching insufficient temperatures to facilitate the fusing of the build powder. This leads to smaller dimension printed parts and/or poor mechanical properties (such as elongation at break, modulus, etc.). As illustrated in FIG. 5, a greater proportion of the energy that is directed towards the powder bed is reflected in the system using white build powder (example on the left) compared to the system using yellowed (oxidized) build powder (example on the right), which results in higher temperatures at the printed parts following the application of an amount of powder-fusing energy to the powder bed.

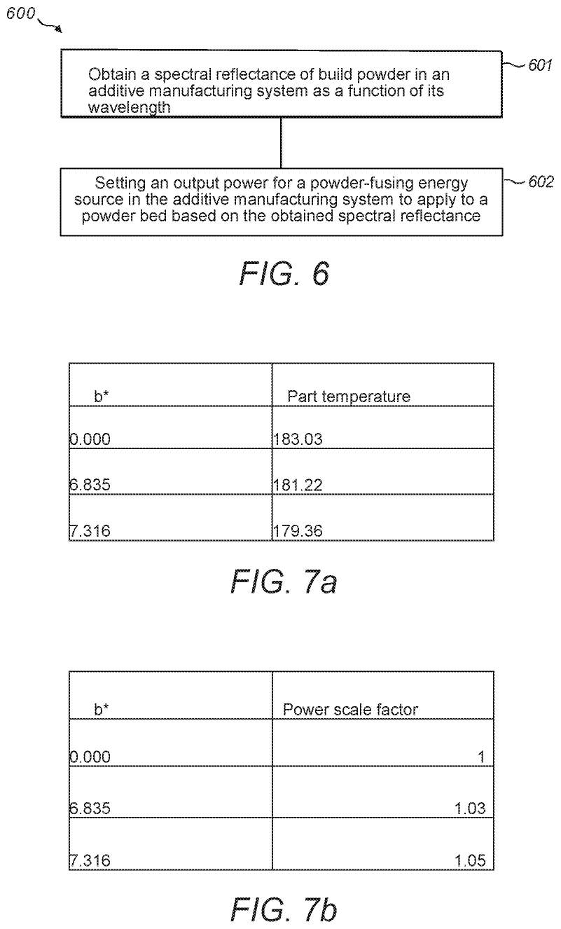

Referring to FIG. 6, there is shown a method 600 for controlling the output power of a powder-fusing energy source. The method 600 begins with the obtaining 601 a spectral reflectance of build powder in an additive manufacturing system 200 for certain wavelengths. Reflectance of the surface of a material represents its effectiveness in reflecting radiant energy. It is the fraction of incident electromagnetic power that is reflected at an interface. The reflectance spectrum or spectral reflectance curve is the plot of the reflectance as a function of wavelength. In an example, the spectral reflectance is obtained by measuring the build powder directly using an optical sensor such as a colorimeter, which in some examples is part of the three-dimensional printing system. The measured colour is indicative of the reflection of visible light, and this is indicative of energy absorption because it is the reflection of visible light and near-IR that varies most as powder oxidizes (whereas deep-IR radiation is highly absorbed by white powder and powder that is discoloured by oxidization). In one example, the spectral reflectance is obtained by an automated inspection of the build powder within a three-dimensional printing system. In another example, the spectral reflectance is obtained by analysing a sample of the build powder away from the three-dimensional printing system. The method further includes using the obtained spectral reflectance to determine 602 a desired output power for a powder-fusing energy source in the additive manufacturing system, to apply an amount of energy to a powder bed in compensation for the differing reflectance of discoloured powder.

The power applied to the powder-fusing energy source may be electrical power, in watts. In other examples, the power applied to the powder-fusing energy source may refer to other ways in which the powder-fusing energy source is actuated, such as voltage in volts or irradiance in watts per square meter.

The method 600 shown in FIG. 6 may be a calibration method and may be performed separately from a printing process for printing a three-dimensional object. The calibration method may be performed periodically, for example before every printing operation, before the printing of each build layer or before the printing of each portion of a build layer. The frequency of performance of the calibration method may depend on the rate of degradation of the lamps, or other parts of the three-dimensional printer, as well as the desired degree of responsiveness to variations in powder colour.

In some examples, the output power for the powder-fusing energy source is determined by comparing the spectral reflectance with a reference value. In some examples, the reference value may correspond to the spectral reflectance of completely white (fresh non-oxidized) build powder (e.g., the highest possible spectral reflectance). In an example, the output power of the powder-fusing energy source is modified from a default output power by an amount dependent of the deviation between the spectral reflectance and the reference value. In some examples, the reference value corresponds to a previous spectral reflectance measurement having a corresponding determined output power. A difference measured between the measured spectral reflectance and the previous spectral reflectance can be used to determine the new output power to compensate for the newly measured spectral reflectance.

In some examples, the output power for the powder-fusing energy source is determined using a quantified relationship between spectral reflectance and final printed part temperature for a given output power. FIG. 7a illustrates the effect that the use of build powder having different spectrophotometric traits has on the final temperature of printed parts following application of the powder-fusing energy. In FIGS. 7a and 7b, the colorization of the build powder is characterized by b*. It is clear from FIG. 7a that build powder having a higher colorization b* (lower spectral reflectance compared to that of pure white build powder) results in a lower printed part temperature for a given output power of the powder-fusing energy source. FIG. 7b illustrates how the output power of the powder-fusing energy source must be modified to achieve a constant printed part temperature for different levels of colorization b*. In some examples, the output power of the powder-fusing energy source is determined via either interpolation or extrapolation of the quantified relationship. This avoids the need for a stored database having a specific output power corresponding to every possible spectral reflectance measurement. In an example, the output power for the powder-fusing energy source is determined using predefined power compensation data. In some examples, the predefined power compensation data is obtained from previous printing operations.

In one example, the method comprises generating printer instructions to control a powder-fusing energy source based on a spectrophotometry measurement of build powder in a three-dimensional printing system 200. In some examples, the generating of printer control instructions involves generating control data which, when run on a computer, causes a three-dimensional printing system 200 comprising a powder-fusing energy source to control the output power of the powder-fusing energy source in accordance with the control instructions. In an example, the control instructions comprise: instructions for the three-dimensional printing system 200 to determine a spectrophotometry measurement for a portion of a layer of build powder in a three-dimensional printing operation; and instructions for the three-dimensional printing system to control an output of the powder-fusing energy source to apply powder-fusing energy to the layer based on the determined spectrophotometry measurement. This example facilitates the adjusting of the output power of the powder-fusing energy source in accordance with the spectrophotometry measured for the build powder. In one example, the control instructions comprise: instructions for the three-dimensional printing system 200 to determine a spectrophotometry measurement at a plurality of locations across the layer of build powder; and

instructions for the three-dimensional printing system 200 to control the output of the powder-fusing energy source to apply powder-fusing energy at each of the plurality of locations based on the spectrophotometry measurement determined for the respective location. This example allows the output power of the powder-fusing energy source to be adjusted across different portions of the build layer in accordance with the measured spectrophotometry at the respective portions of the build layer. In one example the control instructions comprise: instructions for the three-dimensional printing system 200 to determine a spectrophotometry measurement for portions of a set of layers of build powder in the three-dimensional printing operation; and instructions for the three-dimensional printing system 200 to control the output of the powder-fusing energy source to apply powder-fusing energy to each layer in the set of layers based on the determined spectrophotometry measurement for the respective layer of build powder. This example facilitates the adjusting of the output power of the powder-fusing energy source in accordance with the spectrophotometry measured for each respective layer in a set of layers of build powder.

In one example, the instructions to control an output of the powder-fusing energy source include instructions for the three-dimensional printing system 200 to determine a power factor correction value based on the determined spectrophotometry measurement. The power factor correction value reflects the amount in which the output power of a powder-fusing energy source should be modified to compensate for the determined spectrophotometry measurement. In some examples, the power factor correction value is a modifier for applying to the input of the powder-fusing energy source. The power factor correction factor may be determined in a number of other ways, such as those described above.

In one example, the instructions to control an output of the powder-fusing energy source include instructions for the three-dimensional printing system to: predict a change in energy absorption of a printed part based on the spectrophotometry measurement of build powder; and control the powder-fusing energy source to emit an amount of energy to compensate for the predicted change in energy absorption of the printed part. In an example, the energy absorption of the printed part is predicted based on the difference between the spectrophotometry measurement and a reference spectrophotometry measurement having a corresponding reference energy absorption for the printed part. In an example, the prediction is based on previous printing operations. In one example, the instructions to control an output of the powder-fusing energy source include instructions for the three-dimensional printing system to: measure a change in energy absorption of a printed part based on the spectrophotometry measurement of build powder; and control the powder-fusing energy source to emit an amount of energy to compensate for the measured change in energy absorption of the printed part. In some examples, the energy compensation is based on the known relationship between spectrophotometry of the build powder and the temperature of at printed part.

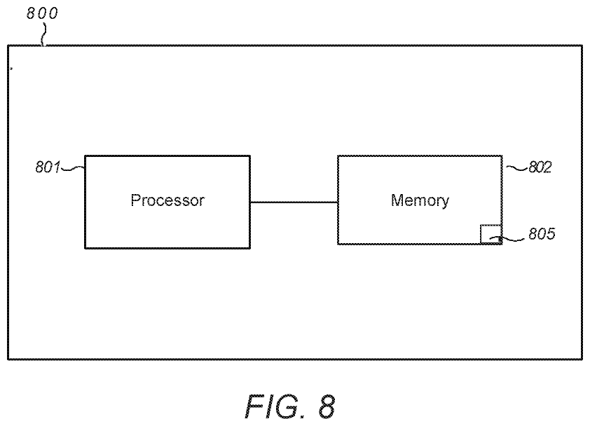

FIG. 8 shows an example of controller 800 configured to generate printer control data. The controller 800 comprises a processor 801 and a memory 802. Stored within the memory 802 are instructions 805 for generating printer control data according to any one of the example methods disclosed above. In an example, controller 800 may be part of a computer running the instructions 805. In another example, controller 800 may be part of a powder-based three-dimensional printing system configured to run the instructions 805 after obtaining object model data.

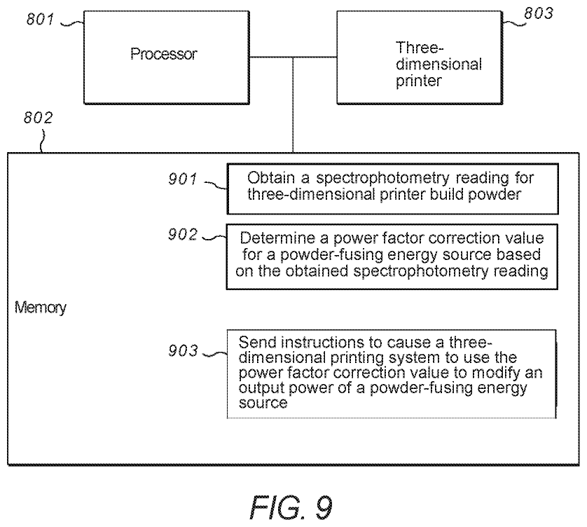

FIG. 9 shows a memory 802 which is an example of a computer-readable medium storing instructions that, when executed by a processor 801 communicably coupled to an additive manufacturing system 803, causes the processor 801 to generate printer control data. The computer-readable medium may be any electronic magnetic, optical or other physical storage device that stores executable instructions. Thus, the non-transient computer readable medium may be, for example, Random Access Memory (RAM), and Electrically-erasable Programmable read-Only Memory (EEPROM), a storage drive, an optical disc, and the like.

The machine-readable storage medium 802 may comprise instructions to control an output power for a powder-fusing energy source based on a spectral reflectance of build powder in a three-dimensional printing system. The machine-readable storage medium may comprise instructions for obtaining 901 a spectrophotometry reading for three-dimensional printing system build powder; and determining 902 a power factor correction value for a powder-fusing energy source based on the obtained spectrophotometry reading; and sending 903 instructions to cause a three-dimensional printing system to use the power factor correction value to modify an output power of a powder-fusing energy source.

According to examples described herein, a powder-fusing energy source may be calibrated such that the temperature of a printed part at a predetermined stage of the fusing cycle is at a target temperature. This may improve uniformity between parts printed by different three-dimensional printers, and may prevent surface defects in the printed parts. Measuring a temperature of a printed part in a calibration method may improve reliability of the calibration.

1. A method comprising:
generating printer control instructions to control a powder-fusing energy source based on a spectrophotometry measurement of build powder in a three-dimensional printing system.

2. The method according to claim 1, wherein the control instructions comprise:
instructions for the three-dimensional printing system to determine a spectrophotometry measurement for a portion of a layer of build powder in a three-dimensional printing operation; and
instructions for the three-dimensional printing system to control an output of the powder-fusing energy source to apply powder-fusing energy to the layer based on the determined spectrophotometry measurement.

3. The method according to claim 2, wherein the control instructions comprise:
instructions for the three-dimensional printing system to determine a spectrophotometry measurement at a plurality of locations across the layer of build powder; and
instructions for the three-dimensional printing system to control the output of the powder-fusing energy source to apply powder-fusing energy at each of the plurality of locations based on the spectrophotometry measurement determined for the respective location.

4. The method according to claim 2, wherein the control instructions comprise:
instructions for the three-dimensional printing system to determine a spectrophotometry measurement for portions of a set of layers of build powder in the three-dimensional printing operation; and
instructions for the three-dimensional printing system to control the output of the powder-fusing energy source to apply powder-fusing energy to each layer in the set of layers based on the determined spectrophotometry measurement for the respective layer of build powder.

5. The method according to claim 2, wherein the instructions to control an output of the powder-fusing energy source include instructions for the three-dimensional printing system to determine a power factor correction value based on the determined spectrophotometry measurement.

6. The method according to claim 1, wherein the instructions to control an output of the powder-fusing energy source include instructions for the three-dimensional printing system to:
predict a change in energy absorption of a printed part based on the spectrophotometry measurement of build powder; and
control the powder-fusing energy source to emit an amount of energy to compensate for the predicted change in energy absorption of the printed part.

7. The method according to claim 1, wherein the instructions to control an output of the powder-fusing energy source include instructions for the three-dimensional printing system to:
measure a change in energy absorption of a printed part based on the spectrophotometry measurement of build powder; and
control the powder-fusing energy source to emit an amount of energy to compensate for the measured change in energy absorption of the printed part.

8. A three-dimensional printing system comprising:
a powder-fusing energy source; and
a controller configured to:
obtain a spectral reflectance of build powder in an additive manufacturing system as a function of its wavelength; and
set an output power for the powder-fusing energy source in the additive manufacturing system to apply to a powder bed based on the obtained spectral reflectance.

9. The system according to claim 8, comprising a colorimeter or another type of sensor configured to measure a spectral reflectance of build powder in an additive manufacturing system.

10. The system according to claim 8, wherein the controller is configured to determine a required output power by comparing the spectral reflectance with a reference value.

11. The system according to claim 10, wherein the determined output power is modified from a default output power by an amount dependent of the deviation between the spectral reflectance and the reference value.

12. The system according to claim 8, wherein the output power is determined using a quantified relationship between spectral reflectance and final printed part temperature for a given output power.

13. The system according to claim 12, wherein the output power is determined via interpolation or extrapolation of the quantified relationship.

14. The system according to claim 8, wherein the output power is determined using predefined power compensation data.

15. A computer-readable medium comprising instructions, which when executed on a computer, cause the computer to carry out the steps of:
obtaining a spectrophotometry reading for three-dimensional printing system build powder; and
determining a power factor correction value for a powder-fusing energy source based on the obtained spectrophotometry reading; and
sending instructions to cause a three-dimensional printing system to use the power factor correction value to modify an output power of a powder-fusing energy source.
